(19) United States
(12) Patent Application Publication
(10) Pub. No.: US 2026/0180498 A1
(43) Pub. Date: Jun. 25, 2026

(54) Wind Deflector Clamp for PV Panel Installation

(71) Applicant: Top Rack Technology, Inc., Moorestown, NJ (US)

(72) Inventor: Guohao Zhu, Haining City (CN)

(73) Assignee: Top Rack Technology, Inc., Moorestown, NJ (US)

(21) Appl. No.: 19/211,859

(22) Filed: May 19, 2025

(30) Foreign Application Priority Data
Dec. 19, 2024 (CN) 202423133901.6

(51) Int. Cl. H02S 30/10; F16B 2/06; F16B 5/06

(52) U.S. Cl. CPC H02S 30/10; F16B 2/065; F16B 5/0685

(57) ABSTRACT

The present disclosure relates to a wind deflector clamp for PV panel installation, comprising an upper wind deflector fixing block, a lower wind deflector fixing block, and a wind deflector pressing block. The design allows for a quick and secure installation with easy engagement between the wind deflector and the clamp mechanism.

### TECHNICAL FIELD

The present utility model relates to the field of solar photovoltaic (PV) technology, specifically to a wind deflector clamp for PV panel installation.

### BACKGROUND TECHNOLOGY

Currently, rooftop-mounted PV systems primarily consist of solar panels and mounting structures, with panels being secured to rooftops via PV mounting brackets. Conventional PV mounting systems generally include:
Mounting bases,
Rails and rail mounting components,
Mid clamps, and
End clamps.

However, wind deflectors are rarely included in existing PV mounting structures, despite their critical role in improving the overall stability and wind resistance of the system. Wind deflectors shield the PV array from strong winds, protecting the solar PV system from potential damage. Even when wind deflectors are incorporated, their installation is often cumbersome, and they lack stability after installation, making them prone to detachment under harsh weather conditions.

### SUMMARY OF THE UTILITY MODEL

To address the limitations of existing technology, the present utility model provides a wind deflector clamp for PV panel installation, which enables quick and secure attachment of wind deflectors while ensuring high structural stability.

### Technical Solution

To achieve the above objectives, the present utility model provides a wind deflector clamp for PV panel installation, comprising:
An upper wind deflector fixing block,
A lower wind deflector fixing block, and
A wind deflector pressing block.

### Structural Features

The upper fixing block is designed with:
   An installation pressing plate on one side.
   A strip-shaped guide rail slot on the other side, allowing the wind deflector to slide horizontally after engagement.
The upper and lower fixing blocks are connected via Bolt I, forming an installation groove for secure attachment to the PV panel frame.
The wind deflector pressing block is fastened to the upper fixing block using Bolt II, ensuring the wind deflector remains firmly in place.
A spring mechanism is positioned between the upper fixing block and the pressing block, allowing for elastic connection via Bolt II, which provides shock absorption and flexibility during installation.
Grounding pins are included on both the top of the installation pressing plate and the bottom surface of the lower fixing block, ensuring electrical continuity.
Anti-slip teeth are integrated into the contact surfaces where the upper and lower fixing blocks engage with the PV panel frame, improving stability and preventing slippage.

### Advantages of the Utility Model

Quick and secure installation, allowing the wind deflector to be easily engaged with the clamp mechanism.
High installation stability, ensuring firm attachment even under strong wind conditions.
Adjustable positioning through the guide rail slot, enabling fine-tuning of the wind deflector alignment.
Enhanced durability, thanks to the spring-assisted elastic connection, which helps absorb external forces and reduces stress on the wind deflector structure.
Improved anti-slip design, as the upper and lower fixing blocks include anti-slip teeth, enhancing installation stability.

This wind deflector clamp system is an effective and reliable solution for improving wind resistance and structural integrity in solar PV mounting systems, ensuring long-term durability and operational safety.

### DESCRIPTION OF DRAWINGS

FIG. 1: Structural schematic diagram of the embodiment of the present utility model.

FIG. 2: Exploded structural schematic diagram of the embodiment of the present utility model.

FIG. 3: Schematic diagram of the upper wind deflector fixing block in the embodiment of the present utility model.

FIG. 4: Schematic diagram of the wind deflector pressing block in the embodiment of the present utility model.

FIG. 5: First installation schematic diagram of the embodiment of the present utility model.

FIG. 6: Second installation schematic diagram of the embodiment of the present utility model.

FIG. 7: Schematic diagram of the installed wind deflector system in the embodiment of the present utility model.

These drawings visually represent the components, assembly process, and installation method of the wind deflector clamp for PV panel installation, ensuring clarity and accuracy in the documentation of the present utility model.

### ILLUSTRATION LABELS IN THE DRAWINGS

40—Upper Wind Deflector Fixing Block
41—Lower Wind Deflector Fixing Block
42—Wind Deflector Pressing Block
43—Installation Pressing Plate
44—Strip-Shaped Guide Rail Slot
45—Wind Deflector
46—Bolt I
47—Bolt II
48—Spring
49—Grounding Pin
50—Anti-Slip Teeth
51—Pressing Strip
52—Solar PV Panel Frame

These labels correspond to the components illustrated in the wind deflector clamp system for PV panel installation, ensuring clarity and precision in the documentation.

### DETAILED DESCRIPTION OF THE EMBODIMENT

The following section, in conjunction with the accompanying drawings, provides a clear and complete description of the technical solutions of the embodiments of the present utility model. It is evident that the described embodiments represent only a portion of the possible implementations and not all possible embodiments. Based on the disclosed embodiments, any other implementations obtained by those skilled in the field without making creative efforts fall within the scope of the present utility model.

### Structure of the Wind Deflector Clamp

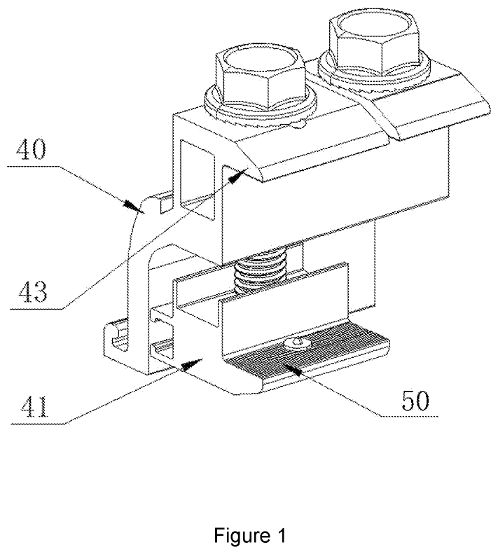

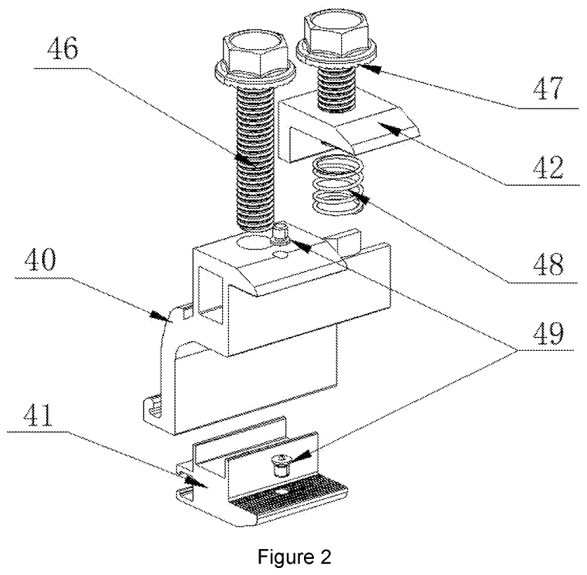

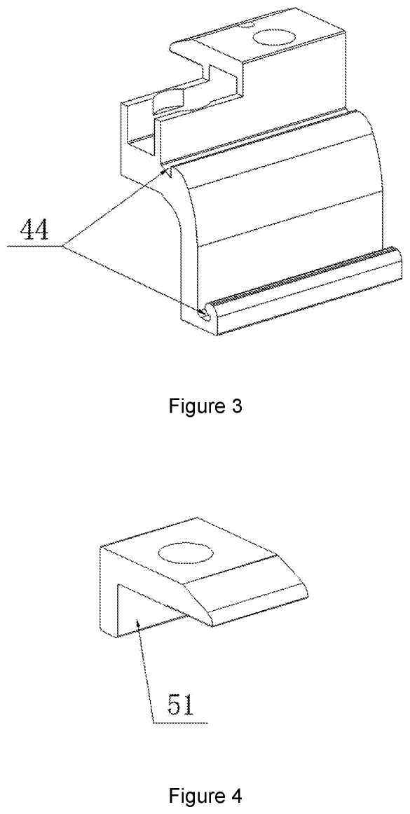

As shown in FIGS. 1 to 3, a wind deflector clamp for PV panel installation is disclosed, comprising:
An upper wind deflector fixing block (40)
A lower wind deflector fixing block (41)
A wind deflector pressing block (42)

### Key Structural Features:

1. Installation Pressing Plate & Guide Rail Slot
The upper fixing block (40) includes:
   An installation pressing plate (43) on one side.
   A strip-shaped guide rail slot (44) on the other side, allowing the wind deflector (45) to slide horizontally after engagement.

2. Connection to the PV Panel Frame
The installation pressing plate (43) and the lower fixing block (41) are connected via Bolt I (46).
This forms an installation groove, enabling secure attachment to the solar PV panel frame (52).
The wind deflector pressing block (42) is attached to the upper fixing block (40) using Bolt II (47).
One side of the wind deflector pressing block (42) is flush with the installation pressing plate (43), while the other side features a pressing strip (51) to secure the wind deflector (45).

3. Spring-Loaded Elastic Connection
A spring (48) is positioned between the upper fixing block (40) and the wind deflector pressing block (42).
The spring (48) is mounted around Bolt II (47), allowing for elastic movement and better shock absorption.

4. Grounding Mechanism for Electrical Continuity
Grounding pins (49) are installed on both:
   The top of the installation pressing plate (43).
   The bottom of the lower fixing block (41).
This ensures electrical continuity with the solar PV panel frame (52).

5. Anti-Slip Design for Enhanced Stability
Anti-slip teeth (50) are incorporated into the contact surfaces where the upper and lower fixing blocks (40, 41) engage with the PV panel frame (52).
This design enhances stability and prevents displacement during operation.

### Installation Process

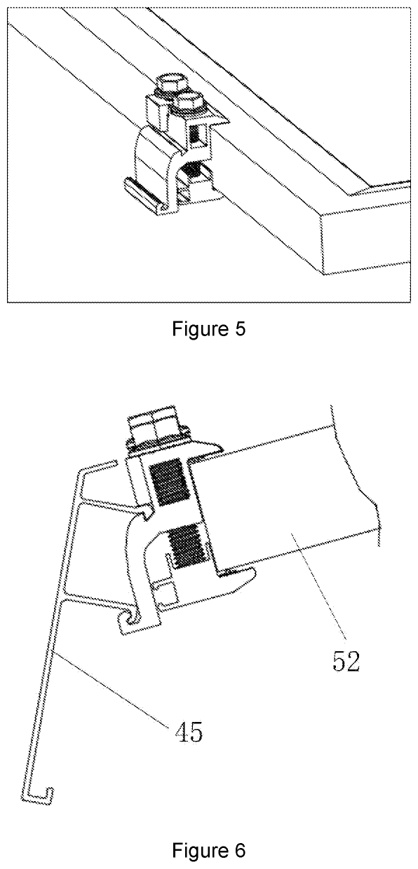

1. Attaching the Wind Deflector Clamp to the PV Panel Frame:
The solar PV panel frame (52) is positioned between the upper fixing block (40) and the lower fixing block (41).
It is secured using Bolt I (46) (as shown in FIG. 5).

2. Inserting and Fixing the Wind Deflector:
The two snap-fit edges of the wind deflector (45) are inserted into the strip-shaped guide rail slot (44).
The pressing strip (51) on the wind deflector pressing block (42) firmly secures the wind deflector (45) (as shown in FIG. 4).
The wind deflector pressing block (42) is locked in place using Bolt II (47) (as shown in FIG. 6).

3. Adjusting the Wind Deflector Position:
Once installed, the wind deflector (45) can slide within the guide rail slot (44) for precise positioning.

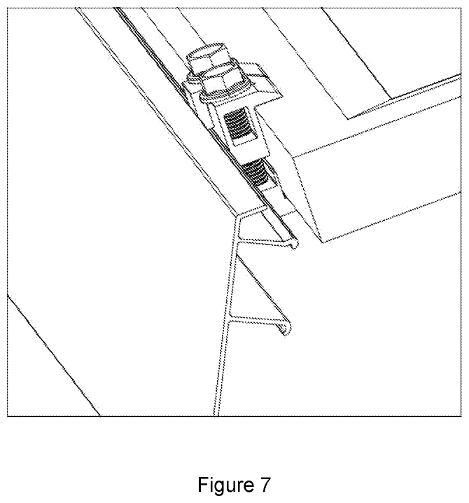

4. Final Installation Effect:
The final secured installation is shown in FIG. 7.

This wind deflector clamp design ensures fast, secure installation, high wind resistance, and long-term durability, making it an efficient solution for solar PV mounting systems.

It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

1. A wind deflector clamp for PV panel installation, characterized in that it comprises an upper wind deflector fixing block (40), a lower wind deflector fixing block (41), and a wind deflector pressing block (42), wherein:
the upper fixing block (40) has an installation pressing plate (43) on one side and a strip-shaped guide rail slot (44) on the other side, which allows the wind deflector (45) to slide horizontally after engagement;
the upper fixing block (40) and the lower fixing block (41) are connected via Bolt I (46), forming an installation groove for secure attachment to the PV panel frame;
the wind deflector pressing block (42) is secured to the upper fixing block (40) using Bolt II (47);
one side of the wind deflector pressing block (42) is flush with the installation pressing plate (43), while the other side features a pressing strip (51) to secure the wind deflector (45).

2. The wind deflector clamp for PV panel installation according to claim 1, characterized in that a spring (48) is positioned between the upper fixing block (40) and the wind deflector pressing block (42), with the spring (48) mounted around Bolt II (47) to provide elastic connection.

3. The wind deflector clamp for PV panel installation according to claim 1, characterized in that grounding pins (49) are provided on both the top of the installation pressing plate (43) and the bottom surface of the lower fixing block (41).

4. The wind deflector clamp for PV panel installation according to claim 1, characterized in that anti-slip teeth (50) are incorporated on contact surfaces where the upper fixing block (40) and the lower fixing block (41) engage with the PV panel frame.
